(19) United States
(12) Patent Application Publication
(10) Pub. No.: US 2019/0108499 A1
(43) Pub. Date: Apr. 11, 2019

(54) Decentralized Digital Token within an App Ecosystem

(71) Applicant: Bing Liu, Rolling Hill, CA (US)

(72) Inventor: Bing Liu, Rolling Hill, CA (US)

(21) Appl. No.: 16/155,061

(22) Filed: Oct. 9, 2018

Related U.S. Application Data
(60) Provisional application No. 62/569,855, filed on Oct. 9, 2017.

(51) Int. Cl. G06Q 20/06; H04L 9/06; G06Q 30/02; G06Q 20/36

(52) U.S. Cl. CPC G06Q 20/0658; H04L 9/0637; G06Q 20/3672; G06Q 30/0236; G06Q 30/0239

(57) ABSTRACT

Decentralized cryptocurrency for use in an application ecosystem. The cryptocurrency uses blockchain technology and a distributed ledger to track performance and transactions. The blockchain uses multiple supernodes to maintain its decentralized data tracking system. Each supernode works as a mining node to verify all transactions. Using a cryptocurrency based on blockchain technology reduces fraud, increases privacy and increases data transparency. The application ecosystem allows for the free flow of the cryptocurrency between applications. Applications include, without limitation, advertising applications, gaming applications, charity applications, and educational applications as part of the application ecosystem.

### PRIORITY

This application claims the benefit of U.S. Provisional 62/569,855, filed Oct. 9, 2017, which is hereby incorporated by reference.

### FIELD OF THE INVENTION

The present invention relates to digital token management, and, more particularly, crypto currency management in a mobile app ecosystem.

### BACKGROUND

A trend in the digital world is the development of mobile app platforms, which will replace websites as the direct channel that connects business and clients, services and users, content providers and audiences, and many more. These interactions have become overly complex and opaque through middleman ad exchanges, inaccurate user tracking and cross party sharing through data management platforms. There is continuing need for a means to reduce fraud while increasing privacy, advertisement efficiency and data transparency.

With the advance of technology and spread of internet access, the world is becoming more connected and people have access to nearly any information they seek. The number of internet users has been growing exponentially. Today, over 3.8 billion people has internet access, which is over 50% of the world's population, and this number is expected to rise. Over the past 20 years, the creation, and usage of websites has been expanding with widespread access to the internet. The number of websites totaled 1 million in 1997, then reached and maintained at a milestone of 1 billion since 2016.

Another growing trend in the digital world is the development of decentralized trust. Utilizing blockchain technology, payments and/or contracts may be performed by distributed consensus and recorded on a blockchain. A blockchain is simply a distributed ledger of all transactions with respect to payments and/or established contracts. Digital coins, such as Bitcoin (BTC) or Ether (ETH), are much more than a digital currency, but a network of trust that provides the basis for so much more than just currencies. Cryptocurrency, such as BTC or ETH, is a collection of concepts and technologies that form the basis of a digital money ecosystem. Units of currency, such as BTC or ETH, are used to store and transmit value among users in the BTC or ETH network. The cryptocurrency is entirely virtual and is distributed in a peer-to-peer system. Cryptocurrencies typically consist of: a decentralized peer-to-peer network, a published transaction ledger, such as a blockchain, a set of rules for independent transaction validation and currency issuance, and a mechanism for reaching global decentralized consensus on the valid blockchain (such as Proof-of-Work or Proof-of-Stake).

### BRIEF SUMMARY OF THE INVENTION

A decentralized data tracking system would be used to coordinate advertising between advertisers and viewers. Advertisers could spend digital currency to reward its viewers. Statistics from these ads may include, but is not limited to, a visitor profile, geological information, and average ad viewing time, or the like, and stored within a decentralized blockchain data storage. While certain user statistics may be stored, personal information (i.e. SSN or a user's real name) may be excluded. Using these statistics, advertisers may assess and evaluate advertisement efficiency and effectiveness, allowing for targeted advertising without the viewer losing their privacy. This method of data tracking and rewarding the viewer can be used in various ways.

The next trend of development in the digital world is mobile application platforms, which will replace websites as the direct channel that connects businesses and clients, services and users, content providers and audiences, and many more. The global number of mobile device users has already exceeded the global number of desktop users. With the upward trend of mobile device usage, there is a huge potential in the app economy. A cryptocurrency empowered by a blockchain smart-contract system may be utilized to facilitate the communications and transactions taking place in a mobile application ecosystem.

The app economy includes revenue derived from all aspects of the app chain, including app stores, in-app advertising, and mobile commerce. By 2021, the app economy is expected to be worth $6 trillion, with an annual growth rate of 37% in 2016. The projected growth of the mobile economy will be primarily driven by the following three factors: mobile-first consumer base, in-app time spent, and shift in consumer app spending habits.

A mobile app platform ecosystem consists of its own mobile app platform products and customized mobile app platforms built for other individuals, organizations, and businesses with unique features such as live streaming and location tracking. Digital currency utilized within the mobile app platform ecosystem would promote the platform, encourage user activity, and facilitate user interaction within the ecosystem.

### BRIEF DESCRIPTION OF THE DRAWINGS

This disclosure is illustrated by way of example and not by way of limitation in the accompanying figure(s). The figure(s) may, alone or in combination, illustrate one or more embodiments of the disclosure. Elements illustrated in the figure(s) are not necessarily drawn to scale. Reference labels may be repeated among the figures to indicate corresponding or analogous elements.

The detailed description makes reference to the accompanying figures in which:

FIG. 1 illustrates an aspect of an exemplary embodiment of the present invention;

FIG. 2 illustrates an aspect of an exemplary embodiment of the present invention;

FIG. 3 illustrates at least one embodiment of the present invention with respect to the supernode;

FIG. 4 illustrates at least one embodiment of the present invention with respect to the application ecosystem;

FIG. 5 illustrates an exemplary embodiment of the circulation of digital coin in a gaming application;

FIG. 6 illustrates an alternative exemplary embodiment of the circulation of digital coin in a gaming application;

FIG. 7 illustrates an exemplary embodiment of the crowdfunding platform; and

FIG. 8 illustrates an exemplary embodiment of a platform in accordance with another embodiment of the invention.

### DETAILED DESCRIPTION

The figures and descriptions provided herein may have been simplified to illustrate aspects that are relevant for a clear understanding of the herein described apparatuses, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

Embodiments are provided throughout so that this disclosure is sufficiently thorough and fully conveys the scope of the disclosed embodiments to those who are skilled in the art. Numerous specific details are set forth, such as examples of specific components, devices, and methods, to provide a thorough understanding of embodiments of the present disclosure. Nevertheless, it will be apparent to those skilled in the art that certain specific disclosed details need not be employed, and that exemplary embodiments may be embodied in different forms. As such, the exemplary embodiments should not be construed to limit the scope of the disclosure. As referenced above, in some exemplary embodiments, well-known processes, well-known device structures, and well-known technologies may not be described in detail.

The terminology used herein is for the purpose of describing particular exemplary embodiments only and is not intended to be limiting. For example, as used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred or required order of performance. It is also to be understood that additional or alternative steps may be employed, in place of or in conjunction with the disclosed aspects.

When an element or layer is referred to as being “on,” “engaged to,” “connected to,” or “coupled to” another element or layer, it may be directly on, engaged, connected or coupled to the other element or layer, or intervening elements or layers may be present, unless clearly indicated otherwise. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). Further, as used herein the term “and/or” includes any and all combinations of one or more of the associated listed items.

Yet further, although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer, or section without departing from the teachings of the exemplary embodiments.

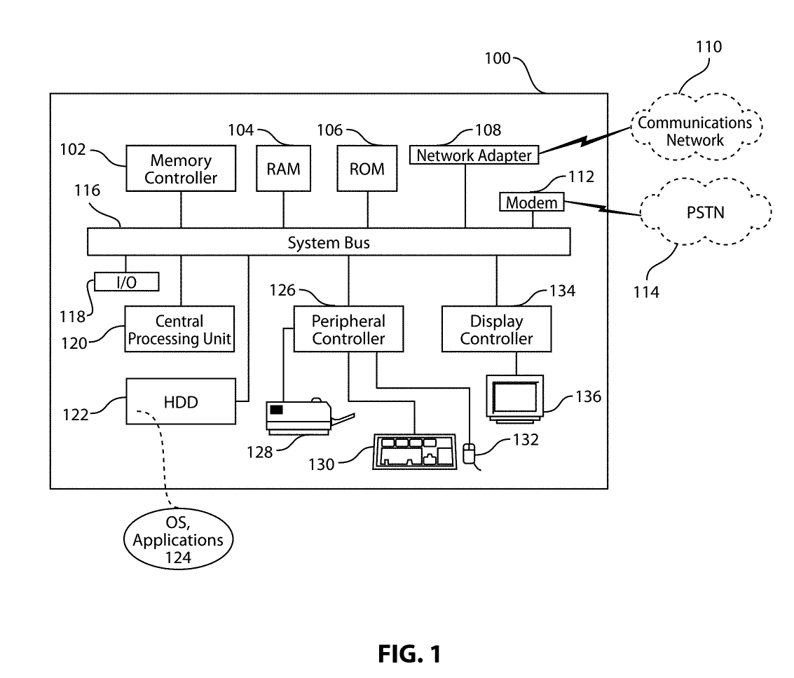

FIG. 1 illustrates an exemplary embodiment of a computer processing system 100 that may receive the various inputs as discussed herein, such as from local or remote sensors or GUIs, and that may perform the processing and logic discussed throughout. That is, the exemplary computing system 100 may be used in accordance with herein described systems and methods.

Computing system 100 is capable of executing software, such as an operating system (OS) and one or more computing applications 124. The software may likewise be suitable for operating hardware, such as via inputs/outputs (I/O), using said applications 124.

The operation of exemplary computing system 100 is controlled primarily by computer readable instructions, such as instructions stored in a computer readable storage medium, such as hard disk drive (HDD) 122, optical disk (not shown) such as a CD or DVD, solid state drive (not shown) such as a USB “thumb drive,” or the like. Such instructions may be executed within central processing unit (CPU) 120 to cause computing system 100 to perform the disclosed operations. In many known computer servers, workstations, PLCs, personal computers, mobile devices, and the like, CPU 120 is implemented in an integrated circuit called a processor.

The various illustrative logics, logical blocks, modules, and engines, described in connection with the embodiments disclosed herein may be implemented or performed with any of a general purpose CPU, a digital signal processor (DSP), an application specific integrated circuit (ASIC), a field programmable gate array (FPGA) or other programmable logic device, discrete gate or transistor logic, discrete hardware components, or any combination thereof, respectively acting as CPU 120. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is appreciated that, although exemplary computing system 100 is shown to comprise a single CPU 124, such description is merely illustrative, as computing system 100 may comprise a plurality of CPUs 124. Additionally, computing system 100 may exploit the resources of remote or parallel CPUs (not shown), for example, through local or remote communications network 110 or some other data communications means.

In operation, CPU 124 fetches, decodes, and executes instructions from a computer readable storage medium, such as HDD 122. Such instructions can be included in the software, such as the operating system (OS), executable programs/applications, and the like. Information, such as computer instructions and other computer readable data, is transferred between components of computing system 100 via the system's main data-transfer path. The main data-transfer path may use a system bus architecture 116, although other computer architectures (not shown) can be used, such as architectures using serializers and deserializers and crossbar switches to communicate data between devices over serial communication paths.

System bus 116 may include data lines for sending data, address lines for sending addresses, and control lines for sending interrupts and for operating the system bus. Some busses provide bus arbitration that regulates access to the bus by extension cards, controllers, and CPU 124. Devices that attach to the busses and arbitrate access to the bus are called bus masters. Bus master support also allows multiprocessor configurations of the busses to be created by the addition of bus master adapters containing processors and support chips.

Memory devices coupled to system bus 116 can include random access memory (RAM) 104 and read only memory (ROM) 106. Such memories include circuitry that allows information to be stored and retrieved. ROMs 106 generally contain stored data that cannot be modified. Data stored in RAM 104 can generally be read or changed by CPU 124 or other communicative hardware devices. Access to RAM 104 and/or ROM 106 may be controlled by memory controller 102. Memory controller 102 may provide an address translation function that translates virtual addresses into physical addresses as instructions are executed. Memory controller 102 may also provide a memory protection function that isolates processes within the system and that isolates system processes from user processes. Thus, a program running in user mode can normally access only memory mapped by its own process virtual address space; it cannot access memory within another process' virtual address space unless memory sharing between the processes has been set up.

The steps and/or actions described in connection with the aspects disclosed herein may be embodied directly in hardware, in a software module executed by a processor locally or remotely, or in a combination of the two, in communication with memory controller 102 in order to gain the requisite performance instructions. That is, the described software modules to perform the functions and provide the directions discussed herein throughout may reside in RAM memory, flash memory, ROM memory, EPROM memory, EEPROM memory, registers, a hard disk, a removable disk, a CD-ROM, or any other form of storage medium known in the art. Any one or more of these exemplary storage medium may be coupled to the processor 124, such that the processor can read information from, and write information to, that storage medium. In the alternative, the storage medium may be integral to the processor. Further, in some aspects, the processor and the storage medium may reside in an ASIC. Additionally, in some aspects, the steps and/or actions may reside as one or any combination or set of instructions on an external machine readable medium and/or computer readable medium as may be integrated through I/O port(s) 118, such as a “flash” drive.

In addition, computing system 100 may contain peripheral controller 126 responsible for communicating instructions using a peripheral bus from CPU 124 to peripherals and other hardware, such as printer 128, keyboard 130, and mouse 132. An example of a peripheral bus is the Peripheral Component Interconnect (PCI) bus.

One or more hardware input/output (I/O) devices may be in communication with hardware controller 118. This hardware communication and control may be implemented in a variety of ways and may include one or more computer busses and/or bridges and/or routers. The I/O devices controlled may include any type of port-based hardware (and may additionally comprise software, firmware, or the like), such as the disclosed sensors and equipment inputs/outputs, and can also include network adapters and/or mass storage devices from which the computer system 100 can send and receive data for the purposes disclosed herein. The computer system 100 may thus be in communication with the Internet or other networked devices via the I/O devices and/or via communications network 110.

Display 136, which is controlled by display controller 134, may optionally be used to display visual output generated by computing system 100. Display controller 134 may also control, or otherwise be communicative with, the display. Visual output may include text, graphics, animated graphics, and/or video, for example. Display 136 may be implemented with a CRT-based video display, an LCD-based display, gas plasma-based display, touch-panel, or the like. Display controller 134 includes electronic components required to generate a video signal that is sent for display.

Further, computing system 100 may contain network adapter 108 which may be used to couple computing system 100 to an external communication network 110, which may include or provide access to the Internet, and hence which may provide or include tracking of and access to the process data discussed herein. Communications network 110 may provide user access to computing system 100 with means of communicating and transferring software and information electronically, and may be coupled directly to computing system 100, or indirectly to computing system 100, such as via PSTN or cellular network 114. For example, users may communicate with computing system 100 using communication means such as email, direct data connection, virtual private network (VPN), or other online communication services, or the like. Additionally, communications network 110 may provide for distributed processing, which involves several computers and the sharing of workloads or cooperative efforts in performing a task. It is appreciated that the network connections shown are exemplary and other means of establishing communications links between multiple computing systems 100, and/or with remote users, may be used.

It is appreciated that exemplary computing system 100 is merely illustrative of a computing environment in which the herein described systems and methods may operate, and thus does not limit the implementation of the herein described systems and methods in computing environments having differing components and configurations. That is, the inventive concepts described herein may be implemented in various computing environments using various components and configurations.

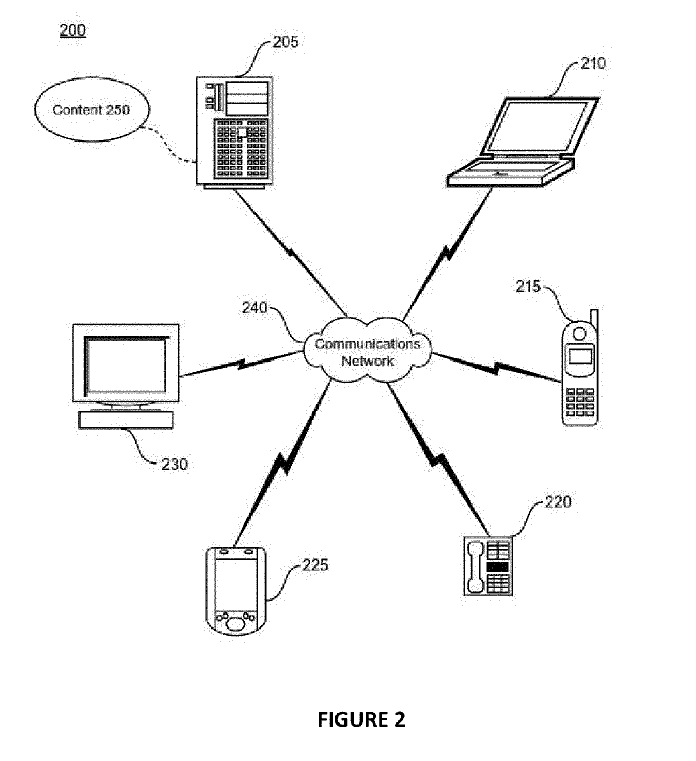

As shown in FIG. 2, computing system 100 can be deployed in networked computing environment 200. In general, the above description for computing system 100 applies to server, client, and peer computers deployed in a networked environment, for example, server 205, laptop computer 210, and desktop computer 230. FIG. 2 illustrates an exemplary illustrative networked computing environment 200, with a server in communication with client computing and/or communicating devices via a communications network, in which the herein described apparatus and methods may be employed.

As shown in FIG. 2, server 205 may be interconnected via a communications network 240 (which may include any of, or any combination of a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone 215, wired telephone 220, personal digital assistant 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), or the like, to interact with server 205.

It is appreciated that exemplary computing system 200 is merely illustrative of a computing environment in which the herein described systems and methods may operate, and thus does not limit the implementation of the herein described systems and methods in computing environments having differing components and configurations. That is, the inventive concepts described herein may be implemented in various computing environments using various components and configurations.

### Advertising System for Mobile Apps Based on Blockchain Technology by Digital Coin

The introduction of the Advertising based on Blockchain technology using digital Coin (ABC) mobile app advertising platform may allow applications or their channel hosts, advertisers, or viewers to reconnect in a decentralized data tracking system that reduces fraud, increases privacy, and increases ad efficiency and data transparency. Advertisers may decide to spend a certain amount of digital coins as a reward to its viewers for a specified unit time spent viewing an advertisement. In one embodiment, the viewers may receive reward coins for watching an advertisement. These coins may be converted into the digital coins used by advertisers to buy the reward coins.

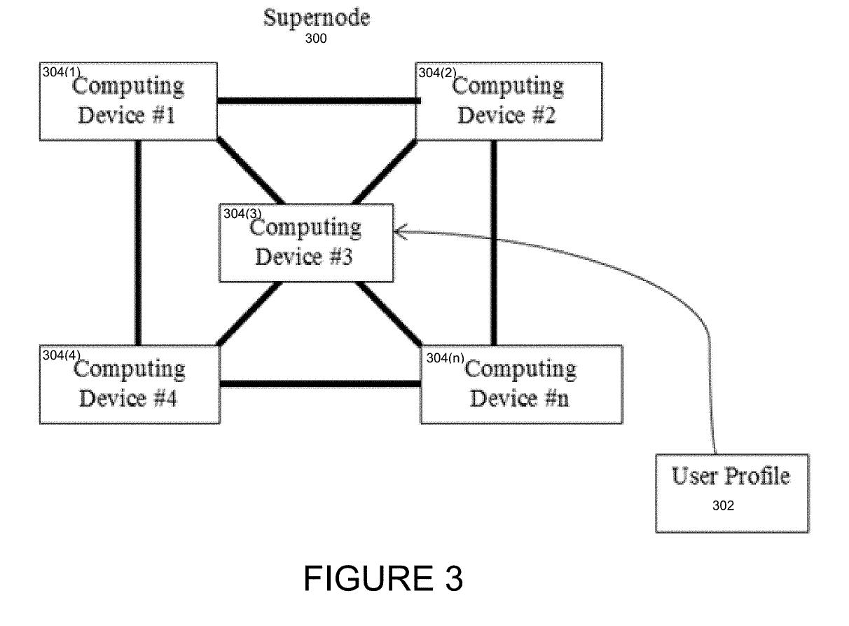

FIG. 3 illustrates an exemplary diagram in accordance with the disclosed invention. The exemplary diagram shows a first supernode 300 of which there be many arranged in a peer-to-peer network, a decentralized blockchain data storage where ad statistic data such as user profiles 302 are tracked and verified. The decentralized blockchain technology disclosed herein may be an open-source, public, blockchain-based distributed computing platform featuring smart contract (scripting) functionality, similar to the Ethereum Network. Each supernode 300 may be a group, or cluster, of at least two computing devices 304(1), 304(2), 304(3), 304(n) that may work as a mining node. The miners produce, through competitive computation, the consensus blockchain, which is the authoritative ledger of all transactions. Each supernode may have different levels of computing, or processing, power. For sake of simplicity, a single supernode is shown, however the system may include more than one supernode, as needed, to perform mining operations and validate transactions, as needed. Further, multiple supernodes may be utilized to maintain copies of the distributed ledger, as described herein. As a mining node, the supernode 300 validates all transactions by reference to a set of consensus rules. Consensus rules are a set of rules for independent transaction validation and digital coin issuance. These rules may reduce fraud by ensuring each computing device 304(1), 304(2), 304(3), 304(n) stays in consensus with the others in the supernode. In one embodiment, each supernode 300 consists of five computing devices, but this number may increase or decrease based on computing power needs. A copy of the distributed ledger is copied, maintained, and propagated by each device 304 of the supernode. As transactions are verified, valid transactions are propagated, or flooded, to all other nodes participating in the network. Based on consensus rules, mining nodes validate transactions and blocks are added to the blockchain accordingly.

A User profile 302 may include geological location, average ad viewing time, number reward coins and the like, but may exclude personal information for the sake of user privacy. Advertisers may use this data to assess and evaluate advertisement efficiency, effectiveness and the like. This data may allow advertisers to deploy more targeted advertisements. User data stored within the blockchain may be accessed using appropriate private/public keys.

Upon obtaining the reward coins, users or publishers may redeem reward coins for digital coins. In one embodiment, the exchange rate between reward coins and digital coins may be determined by the number of reward coins being redeemed. For example, if less users sell reward coins to drive reward coin value up, reward coin amounts for new advertisements will be reduced. Users may then be more willing to hold their reward coin until the value rises again. New digital coins may be issued in a new app ecosystem and based on an existing digital coin utilized in an existing app ecosystem, thereby enabling a new and different ad system in the new app ecosystem.

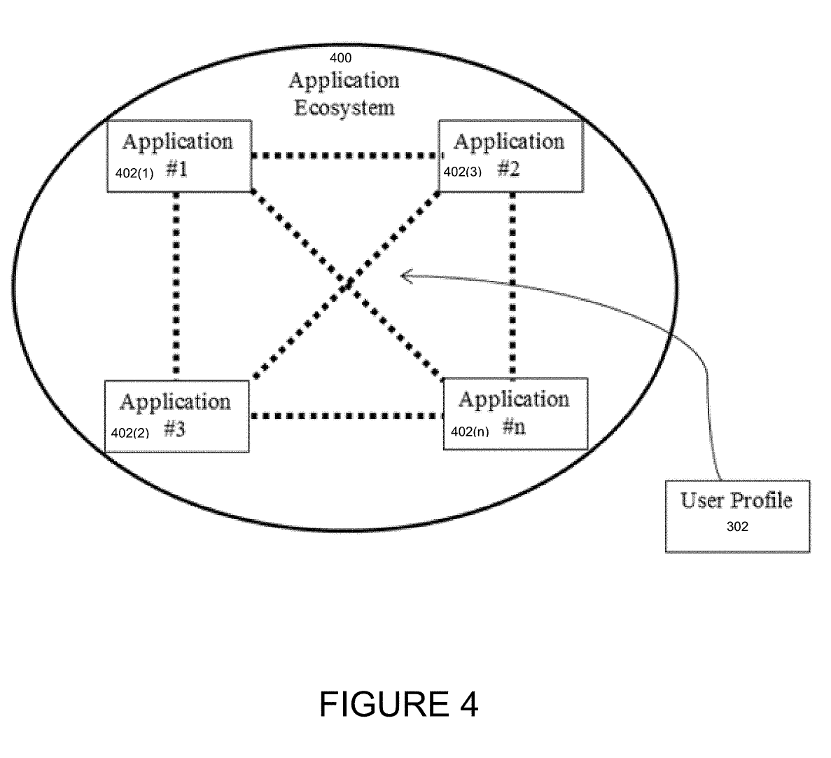

Digital coins may be used in an application ecosystem having two or more applications. One embodiment of this ecosystem is illustrated in FIG. 4. By using one or more of the applications 402(1), 402(2), 402(3), 402(n), the user may enter the application ecosystem 400. The user profile 302, including the user's digital coin amount, would be accessible between different applications and cross-platform. Any change in the user profile 302 may be reflected in each application 402(1), 402(2), 402(3), 402(n) in the ecosystem 400 which is stored within the distributed ledger on the blockchain. The same digital coin and reward coin may be used in each of the applications 402(1), 402(2), 402(3), 402(n). The digital coin may be used to buy products or services in the applications 402(1), 402(2), 402(3), 402(n). Advertisements may be shown in any application to increase user's digital coin. A user's digital coin amount would be maintained by the distributed ledger in conjunction with the supernodes, as described above. The amount of reward digital coin to be transferred between an advertiser and a publisher, viewer, or both, is determined by real world market value exchange rates. For example, if the amount of reward, or payment, is $3 in U.S. currency, it is then determined how much digital coin the $3 converts to based on a floating exchange rate. For example, if the exchange rate is $30 US dollars per digital coin, $3 US dollars is worth 0.10 digital coin. In this example, if a user is rewarded the equivalent of $3 US dollars by an advertiser, then 0.1 digital coin would be transacted as a transfer in value from the advertiser to the user profile. This transaction would be processed by the one or more supernodes 300 and validated by the blockchain distributed ledger.

Any type of application may be included in an application ecosystem. An application ecosystem may include, without limitation, gaming applications, social network applications, educational applications, entertainment applications, charity applications, business applications, and the like.

### Social Gaming Stimulus System by Digital Coin to Reward Social Sharing and Cycle Back with A.I. Training

One type of application in the application ecosystem may be a gaming application platform. In one embodiment, the platform may be a one-to-one mobile gaming platform wherein users, or players, are rewarded digital coins for performing certain actions. Digital coin transaction processing would be performed and handled by the one or more supernodes 300 in accordance with the blockchain distributed ledger described above. Actions within the game may allow the user to gain or lose digital coin, for example, in, response to wins or losses. Users may also be rewarded for promoting the game, such as by sharing a link to the game to a social media platform, or for watching advertisements. In another embodiment, users may need to pay using digital coin to play a certain game on the gaming platform. Advertisers may also buy digital coin to give to users when the advertisements are viewed. Companies may also use the digital coin to send users in-game gifts as a reward. The digital coin may be tracked using each user's profile 302 stored on the supernode 300 in the distributed ledger.

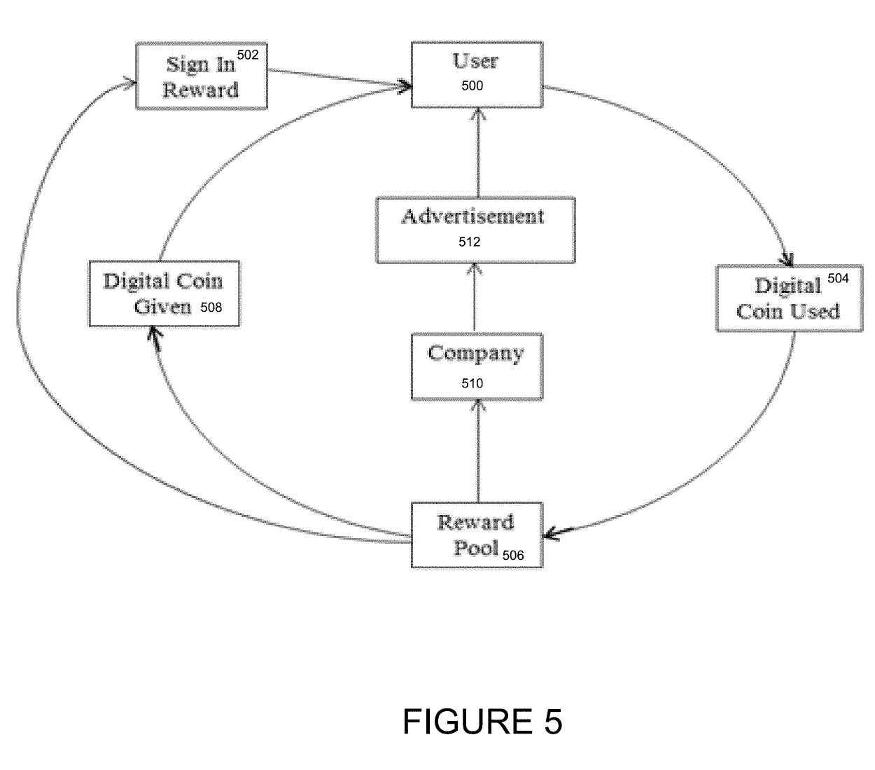

FIG. 5 illustrates an exemplary embodiment of the circulation of digital coins in a gaming application. When the new user 500 initiates a game, they may be required to sign in to their user profile. The new user may receive a reward for signing into their profile for the first time 502. The user may then use the digital coin 504 within one or more applications to perform actions such as playing a game, paying for and receiving training or assessment by an Artificial Intelligence, tipping fellow players, obtaining in-game products, and the like.

Once the digital coin is used, it may be returned to a reward pool 506 which is maintained in a distributed ledger as previously described. The reward pool 506 may be used to recycle digital coin back to the user by giving the user digital coin 508 for various actions. The coin may be given if the user performs actions including, without limitation, sharing the game on social media, inviting other users to play the game, contributing social content, and the like. Advertisers 510 may also purchase the digital coin. The advertisers may give the digital coin to users if the user watches an advertisement 512. The digital coin may be tracked using each user's user profile 302 stored on the supernode 300 in the distributed ledger. In another embodiment, reward coins may be expended by a user to point and attract augmented reality (“AR”) objects. Using the camera of a user's mobile device, a user can “catch” an AR object. In one instance, the AR object may be associated with a certain restaurant or place of business. After catching the object, the user may be forwarded or sent to a landing page associated with the certain restaurant or place of business. Further, a user may be awarded a certain portion of digital coin for catching an AR object, the transaction of which may be verified by the distributed ledger.

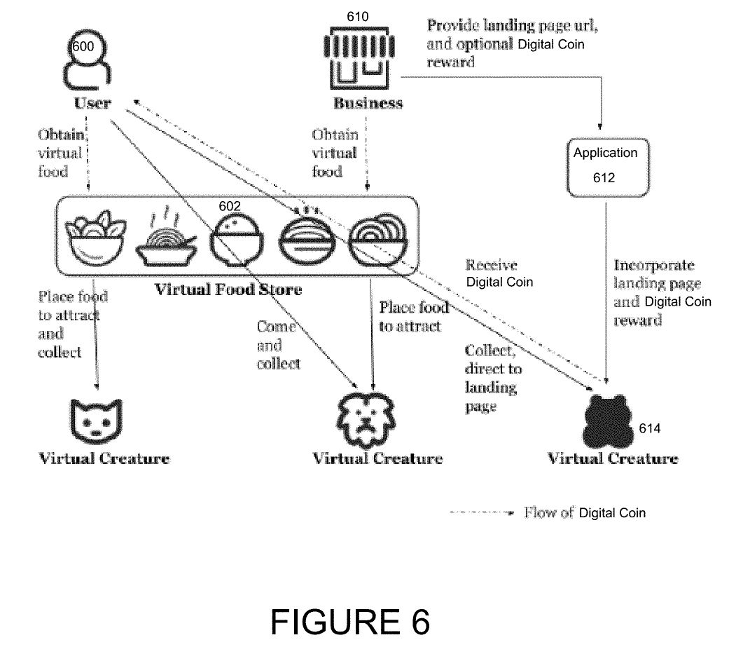

FIG. 6 illustrates an alternative exemplary embodiment of the circulation of digital coin in a gaining application. The user 600 may spend digital coin to obtain in-game products 602. The products 602 may then be used. In one embodiment of this application, the product 602 may attract a virtual creature that the user may interact with. Business 610 may buy digital currency to buy in-game products 602. The business 610 may then reward users 600 with the in-game products 602. In one embodiment, the user 600 may be rewarded for watching an advertisement. The business 610 may also use the in-game product 602. Users may only participate in using the product as a reward for meeting certain conditions. These conditions may include, without limitation, watching an advertisement, physically visiting a geographical location, and the like.

A business 610 may also provide information to the application 612. This information may include, without limitation, the business' website URL. The business 610 may then spend digital coin to create an effect 614 in the form of a virtual creature, for example, in the game application. If the user triggers the effect, they may receive digital coin and the user may be sent to the company's website. If the user captures the creature, they receive the digital coin and are sent to the business' website. The digital coin may be tracked using each user's user profile 302 stored on the supernode 300 utilizing the distributed ledger.

### Fundraising Campaign Stimulus System by Reward-Driven Re-Campaign

In accordance with another embodiment of the disclosed invention, another type of application in the application ecosystem may be a crowdfunding platform. With a fundraiser's permission, a donor may help promote the campaign by starting a new campaign that raises money for the original campaign. The original fundraiser may need a pool of digital currency. Each person who promotes the original campaign, and meets a fundraising goal, may receive digital currency from the pool as a reward. To determine who meets these goals, performances and transactions may be tracked using the distributed ledger in accordance with the above-described embodiments.

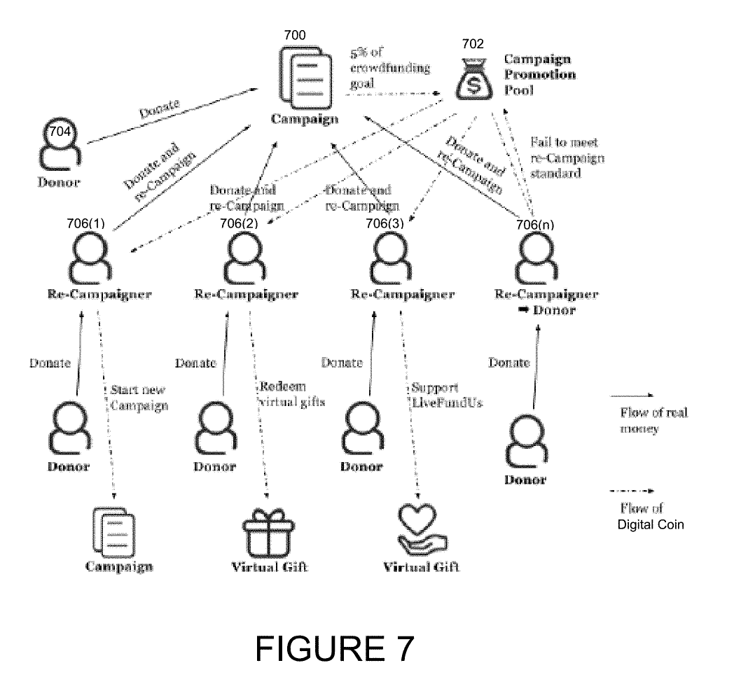

FIG. 7 illustrates an exemplary embodiment of the crowdfunding platform. The user may create a campaign 700. The user may need to create a promotion pool 702. The promotion pool 702 may need to be filled with a certain amount of digital coin. In one embodiment, the amount of money may need to be at least 20% of the total crowdfunding goal. The user may allow one or more donors 704 to donate to the campaign directly. The user may also allow individuals to become a Re-Campaigner 706(1), 706(2), 706(3), 706(n) to further promote the campaign cross-platform. To become a Re-Campaigner 706, the individual may create a new campaign that raises money for the original campaign 700. The user may create a standard that each Re-Campaigner 706(1), 706(2), 706(3), 706(n) needs to follow. The standard may include, without limitation, raising a certain amount of money, having a certain number of donors, and the like. If the Re-Campaigner 706(1), 706(2), 706(3), 706(n) meets the standard, they may receive digital coin from the promotion pool 702. The Re-Campaigner 706(1), 706(2), 706(3), 706(n) may then use the digital coin for various purposes including, without limitation, starting their own campaign, redeeming virtual gifts, sending other users virtual gifts, donating the digital coin to another campaign, using the digital coin in other applications in the application ecosystem, and the like. The digital coin may be tracked using each user's user profile 302 stored on the supernode 300 utilizing the distributed ledger. A separate profile may be created for each campaign and re-campaign.

### Decentralized AMA Bot Based on Blockchain Technology

Another type of application in the application ecosystem may be a decentralized. Ask Me Anything (AMA) platform. The platform may match experts in a specific area with at least one user who needs advice or assistance on a certain topic in, that specific area. Experience may be determined by the platform tracking statistical data by tracking performance and user feedback. This expert may not need to be another user. Alternatives, such as Artificial Intelligence services, may be used. After assistance is provided, the user may transfer a certain amount of digital currency to the expert as compensation utilizing the distributed ledger. Over time, most effective experts may be identified based on performance tracking. Knowledge seekers may submit questions anonymously and experts may submit answers anonymously. The decentralized record-keeping would ensure authenticity while maintaining the anonymity of all parties involved in the AMA platform.

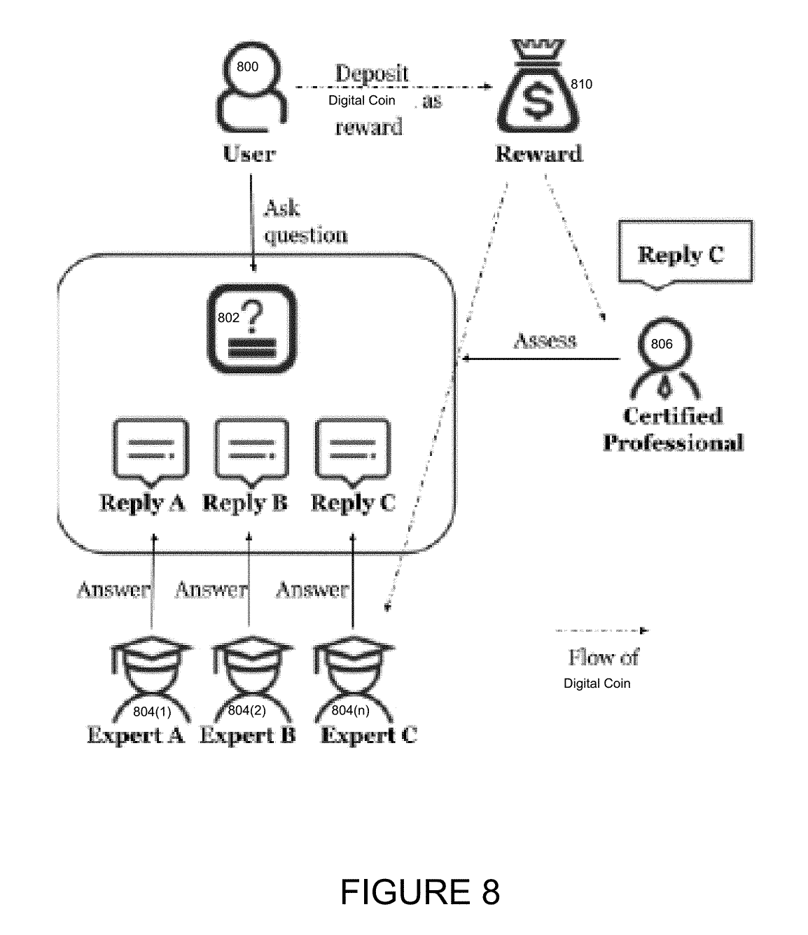

FIG. 8 illustrates an exemplary embodiment of the AMA platform. A user 800 may ask a question 802 to the platform. The platform may require the user 800 to deposit a reward 810. Reward deposit may be conducted by transferring a certain amount of digital coin from the user to a trust account and accounted for by the distributed ledger. Multiple experts 804(1), 804(2), 804(n) may reply to the question 802. The experts 804(1), 804(2), 804(n) may be other users 800 or another source including, without limitation, an Artificial Intelligence and the like. Once the user 800 is satisfied with the responses the user 800 may end the question 802. A certified professional 806 may review the replies after the question 802 is ended. The certified professional 806 may be an administrator that is an expert in the field to which the question relates. The certified professional 806 may rank the responses to the question 802. The user 800 may also review the replies and rank the experts 804(1), 804(2), 804(n).The reward 810 may then be split between the certified professional 806 and the experts 804(1), 804(2), 804(n). The reward 810 awarded to each expert 804(1), 804(2), 804(n) may be dependent on the rank that the certified professional 806 gave to each expert 804(1), 804(2), 804(n).

The amount of digital coin a user owns may be tracked using each user's user profile 302 stored on the supernode 300 by interacting with the distributed ledger maintained by the one or more supernodes. The responses of each expert 804(1), 804(2), 804(n) and the rankings given by the user 800 and the certified professional 806 may be recorded and stored in the expert's user profile. This data may be used to track the performance of each expert. This data may also be used to match each user with the most effective experts. Because the user profiles are stored in a decentralized system, the users and experts may remain anonymous while maintaining the authenticity of each question and answer session.

Those of skill in the art will appreciate that the herein described apparatuses, engines, devices, systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the disclosure, any appended claims and any equivalents thereto.

In the foregoing detailed description, it may be that various features are grouped together in individual embodiments for the purpose of brevity in the disclosure. This method of disclosure is not to be interpreted as reflecting an intention that any subsequently claimed embodiments require more features than are expressly recited.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

I claim:

1. A system for conducting one or more transactions via a block-chain in a mobile application ecosystem, comprising:
a peer-to-peer network, comprising:
one or more super nodes:
one or more mobile devices each associated with at least one user;
one or more other devices each associated with at least one business entity;
a distributed ledger, mined and replicated by the one or more super nodes, configured to maintain a block-chain, wherein the block-chain comprises one or more blocks of data.

2. The system of claim 1, wherein each super node comprises a cluster of computing devices of differing processing capacity.

3. The system of claim 1, wherein the one or more blocks of data comprises user profile data associated with the at least one user.

4. The system of claim 1, wherein the one or more blocks of data comprises crypto-currency transactions.

5. The system of claim 1, wherein each of the one or more blocks of data is accessible via URL and is identified by at least one of: an address, a transaction hash, block number, or block hash.

6. A supernode, comprising:
a cluster of two or more computing devices each configured to:
facilitate decentralized blockchain data storage;
maintain one or more user profiles;
perform mining operations; and
validate transactions.

7. The supernode of claim 6, wherein the one or more user profiles are tracked and verified by the cluster.

8. The supernode of claim 6, wherein each of the one or more user profiles includes at least one of: geological location, average ad viewing time, and number of reward coins.

9. The supernode of claim 6, wherein data associated with the one or more user profiles is encrypted using one or more public and private keys.

10. A method for decentralizing a digital currency in an application ecosystem, with at least one the computing device, the method comprising:
maintaining, by a supernode, a distributed ledger;
facilitating buying and selling of a digital currency; and
conducting transactions utilizing the digital currency amongst two or more applications within the application ecosystem;
wherein the digital currency and profiles of each of the users is maintained by the distributed ledger.

11. The method of claim 10, wherein the distributed ledger is a blockchain.

12. The method of claim 10, wherein the supernode comprises a cluster of two or more computing devices.

13. The method of claim 10, wherein each of the two or more applications include at least one of gaming applications, social network applications, educational applications, entertainment applications, charity applications, and business applications.
